(19) United States
(12) Patent Application Publication
(10) Pub. No.: US 2014/0282253 A1
(43) Pub. Date: Sep. 18, 2014

(54) METHOD AND APPARATUS FOR BATCH SELECTION OF MULTIPLE IMAGES

(71) Applicant: Tencent Technology (Shenzhen) Company Limited, Shenzhen City (CN)

(72) Inventors: Liang ZENG, Shenzhen City (CN); Lei CHEN, Shenzhen City (CN)

(73) Assignee: Tencent Technology (Shenzhen) Company Limited, Shenzhen City (CN)

(21) Appl. No.: 14/263,835

(22) Filed: Apr. 28, 2014

Related U.S. Application Data
(63) Continuation of application No. PCT/CN2013/090308, filed on Dec. 24, 2013.

(30) Foreign Application Priority Data
Mar. 14, 2013 (CN) 201310082040.0

(51) Int. Cl. G06F 3/0484; G06F 3/0488

(52) U.S. Cl. CPC G06F 3/04842; G06F 3/0488
USPC 715/833

(57) ABSTRACT

The present invention relates to the technology field of touch screen device, and provides a method and apparatus for multi-image batch selection. The method comprise: detecting slide touching event under an image editing mode; acquiring a slide track of the slide touching event; and setting unselected images within image display areas that the slide track passes through as being selected. The invention achieves the flexible batch selection of multi-image that are displayed continuously or uncontinuously.

### CROSS-REFERENCE TO RELATED APPLICATIONS

This application is a U.S. continuation application of International Application PCT/CN2013/090308, with an international filing date of Dec. 24, 2013, which claims the priority benefit of Chinese Patent Application No. 201310082040.0 filed on Mar. 14, 2013, the contents of which are both incorporated herein by reference in their entireties for all intended purposes.

### FIELD OF THE INVENTION

The invention relates to a technology field of touch screen device, and in particular, to a method and apparatus for batch selection for multiple images.

### BACKGROUND

Currently, in an editing interface of many applications of a touch screen device, for example Photos of iOS operating system and Photo of QQ browser, it is possible to implement a batch selection for multi-image to perform further operations on the images, such as deleting, sharing, or uploading, etc. The existing methods for batch selection of the multi-image can be generally classified into two ways: 1) selecting image one by one, which requires a lot of operation actions and the selection efficiency is relatively low; and 2) selecting a starting image and an ending image by the user and setting all the images between the starting image and the ending image as a selected state. The latter could conveniently achieve batch selection of successive images and has a high efficiency and easy operations; however, in this way, the images that are not displayed continuously may not be selected flexibly in a batch selection.

### SUMMARY OF THE INVENTION

There is provided a method and apparatus for batch selection of multiple images, which is intended to solve the problem of the prior art wherein it is unable to implement a batch selection for uncontinuous images in a flexible way.

In one aspect of the invention, there is provided a batch selection method for multiple images, comprising:

detecting a slide touching event under an image editing mode;

acquiring a slide track of the slide touching event; and

setting unselected images within the image display area that the slide track passes through as a selected state.

In another aspect of the invention, there is provided a batch selection apparatus for multiple images, comprising:

a detection unit, configured to detect a slide touching event under an image editing mode;

a track acquisition unit, configured to acquire a slide track of the slide touching event;

an image selection unit, configured to set unselected images within the image display area that the slide track passes through as a selected state.

In the embodiments of the invention, a slide touching event under an image editing mode is detected, and a slide track of the slide touching event is acquired; and unselected images within the image display area that the slide track passes through are set as a selected state; by this configuration, the invention achieves a flexible batch selection for multiple images that are displayed continuously or uncontinuously.

### DESCRIPTION OF THE DRAWINGS

FIG. 1 is a flow diagram for implementing a batch selection method for multiple images in accordance with Embodiment 1 of the invention;

FIG. 2a is an exemplary diagram of the batch selection method for multiple images in accordance with Embodiment 1 of the invention;

FIG. 2b is another exemplary diagram of the batch selection method for multiple images in accordance with Embodiment 1 of the invention;

FIG. 2c is another exemplary diagram of the batch selection method for multiple images in accordance with Embodiment 1 of the invention;

FIG. 3 is a flow diagram for implementing a batch selection method for multiple images in accordance with Embodiment 2 of the invention;

FIG. 4 is a flow diagram for implementing a batch selection method for multiple images in accordance with Embodiment 3 of the invention; and

FIG. 5 is a detailed structure diagram of a batch selection apparatus for multiple images in accordance with Embodiment 4 of the invention.

### DETAILED DESCRIPTION

To better illustrate the purpose, technical solution and advantages of the present invention, the present invention will be further described in detail in conjunction with the accompanying drawings and embodiments in the below. It should be appreciated that the detailed embodiments described hereby are only for explaining, instead of defining the invention.

In the present embodiments, a method comprises detecting a slide touching event under an image editing mode, and acquiring a slide track of the slide touching event; and setting unselected images within the image display area that the slide track passes through as a selected state.

The implementation of the invention will be described in detail in conjunction with the detailed embodiments in the below:

### Embodiment 1

FIG. 1 shows a flow diagram for implementing a batch selection method for multiple images in accordance with Embodiment 1 of the invention, and the detailed descriptions are as follows.

It should be noted that the present embodiment and the embodiments below may be applied to a touch screen device utilizing various operating systems, the operating systems comprising, not limited to, iOS, android, windows phone, and the like.

In step S101, a slide touching event under an image editing mode is detected.

In this embodiment, the image editing mode is one of predefined modes of performing relevant operations on the images, such as selecting, deleting, uploading, etc. The status of an image is divided into a selected state and a unselected state. The slide touching event includes a slide-up touching event, a slide-down touching event, a slide-left touching event, a slide-right touching event, or an irregular slide touching event to any direction, etc. There is no limitation on the direction of the slide touching event, and its direction has an connection with the distribution of the images to be selected.

In step S102, a slide track of the slide touching event is acquired.

In this embodiment, if any slide touch event is detected, the touch screen device may acquire a slide track according to a continuous change of coordinates corresponding to the touching points.

In step S103, unselected images within the image display area that the slide track passes through are set as a selected state.

In the present embodiment, the step of setting the unselected images within the image display area that the slide track passes through as the selected state may be implemented in detail as follows:

when there exists at least one touch point of the slide track whose coordinate in the current interface is included in the image display area, the unselected images within the image display area are set as the selected state.

In particular, the image display area may be interpreted as the coordinate range that the images occupy in the current interface. Different images have different display positions. Thus, the image display areas of different images differ from each other. When there exists at least one touch point of the slide track whose coordinate in the current interface is included in the image display area, the unselected images within the image display area will be set by the touch screen device as the selected state, and the process continues until the slide track is completed. The slide track acquired by every slide touching event is continuous under the image editing mode. Therefore, a batch selection for selecting images that are displayed continuously or uncontinuously at once can be achieved flexibly.

For example, an application scene of the present embodiment will be described below by using a plurality of thumbnails in a thumbnail interface in an album as a specific object. However, please be noted that selection of thumbnails is only an example the present invention can be applied to, and the embodiments of the present invention can be applied to selection of various other objects, such as an original image, a representative icon, and so on. The application scene can be described as follows.

As shown in FIG. 2a, in the editing interface, a user slides from the first thumbnail image of the first column down to the fourth thumbnail image of the first column. All of the images within the slide area are set as the selected state. As shown in FIG. 2b, in the editing interface, the user slides from the first thumbnail image of the first row right to the fourth thumbnail image of the first row, and all of the images within the slide area are set as the selected state. As shown in FIG. 2c, in the editing interface, the user slides from the first thumbnail image of the first row right to the fourth thumbnail image of the first row, and then slides left which passes through the third thumbnail image of the second row, the second thumbnail image of the third row, and the first thumbnail image of the forth row, and then slides right to the fourth thumbnail image of the fourth row and ends the sliding. Eight images picked up in FIG. 2c are set as the selected state, and then these images may be operated by deleting, uploading, sharing, etc., according to the purpose of the user.

As can be seen, in the present embodiment, it is possible to set a batch of images that the slide track passes through as the selected state, thereby achieving a more flexible selection of images and achieves a high selection efficiency.

### Embodiment 2

FIG. 3 shows a flow diagram for implementing a batch selection method for multiple images in accordance with Embodiment 2 of the invention, and the detailed descriptions are as follows.

In step S301, a slide touching event under an image editing mode is detected.

In step S302, a slide track of the slide touching event is acquired. In the present embodiment, the execution process in step S301 and step S302 is similar to the process of step S101 in Embodiment 1, and thus the description about Embodiment 1 may be referred to for details.

In the present embodiment, the execution process in step S303 is similar to the process of step S103 in Embodiment 1, and thus the description about Embodiment 1 may be referred to for details.

In the present embodiment, the slide track may pass through the image that has already been selected. Thus, if the image within the image display area that the slide track passes through is in the selected state, the touch screen device may also set the status of the selected image as the unselected state. Hence, it is possible to achieve a batch conversion of the status of images and achieve a batch cancellation of the selected images.

Therefore, in the present embodiment, it is possible to achieve a batch selection or a batch cancellation of multiple images corresponding to the slide track, thereby making the selection of images more flexible.

### Embodiment 3

FIG. 4 shows a flow diagram for implementing a batch selection method for multiple images in accordance with Embodiment 3 of the invention, and the detailed descriptions are as follows.

In step S401, a plurality of slide touching events under an image editing mode are detected, and according to one detected slide touching event, a slide track of the slide touching event is acquired. Each slide touching event corresponds to one slide track.

In the present embodiment, the touch screen device detects a plurality of slide touching events under an image editing mode, and according to one detected slide touching event, acquires a slide track of the slide touching event.

In step S402, unselected images within the image display area that the slide track passes through are set as the selected state, and the next slide touching event is detected, until another operation instruction is received.

In the present embodiment, said operation instruction includes, but not limited to, the instruction of deleting, uploading and exiting editing mode. In the forming process of one slide track, the touch screen device sets the unselected images within the image display area that the slide track passes through as the selected state, and then the next slide touching event is detected, until another operation instruction is received. Under the image editing mode, the slide track acquired by each slide touching event is continuous, while the slide tracks between different slide touching events may be uncontinuous. Therefore, it is possible to achieve a plurality of batch selections for images that are displayed continuously or uncontinuously.

Therefore, it is possible to achieve a batch selection for a plurality of images corresponding to a plurality of slide tracks, such that the operations are more flexible.

### Embodiment 4

FIG. 5 shows a detailed structure diagram of a batch selection apparatus for multiple images in accordance with Embodiment 4 of the invention. For convenience, only the part that is relevant to the embodiment of the present invention is shown. In the present embodiment, the batch selection apparatus for multiple images includes a detection unit 50, a track acquisition unit 51 and an image selection unit 52.

The detection unit 50 is configured to detect a slide touching event under an image editing mode;

the track acquisition unit 51 is configured to acquire a slide track of the slide touching event; and

the image selection unit 52 is configured to set unselected images within the image display area that the slide track passes through as a selected state.

In a further step, the image selection unit 52 is specifically configured to set, when there exists at least one touch point of the slide track whose coordinate in the current interface is included in the image display area, the unselected images within the image display area as the selected state, or the selected images within the image display area as the unselected state. In the circumstance of the latter, the image selection unit 51 may also be called an image un-selection unit.

Further, the detection unit 50 is specifically configured to detect a plurality of slide touching events under an image editing mode;

the track acquisition unit 51 is specifically configured to acquire a slide track of the slide touching event, according to one detected slide touching event; and

the image selection unit 52 is further specifically configured to set the unselected images within the image display area that the slide track passes through as the selected state, and continue the detection of the next slide touching event, until another operation instruction is received.

The batch selection apparatus for multiple images in accordance with embodiments of the invention may be applied to implement the corresponding methods as stated above. The detailed description for the methods has been set forth above and is omitted herein.

The batch selection apparatus may run one of the following mobile operating systems: Symbian OS, iOS, Blackberry, Windows Phone, Linux, Web OS, Android, Tizen. The batch selection apparatus may also run one of the following desktop operating systems: UNIX, OS X, Linux, Chromium OS, Windows.

It should be noted that each unit included in the foregoing embodiment is just classified by its logic function, and the classification is not limited to this way, as long as the corresponding function can be achieved; further, the name assigned to each functional unit is only used to distinguish from each other, rather than to limit the protection scope of the present invention.

Please note that the batch selection apparatus for multiple images provided by the embodiment of the present invention can be applied in various terminal devices utilizing the touch screen device, the terminal devices comprising, but not limited to, a mobile phone, a tablet computer (including Apple iPad and the tablet executing various other operating systems), a smart phone, an e-reader, an on-vehicle terminal, and the like. The detailed structure of these terminal devices is omitted herein.

Furthermore, it will be appreciated by those skilled in the art that all or a part of the procedures in the above-mentioned methods of the embodiments may be implemented by using a computer program to instruct relevant hardwires, wherein the computer program may be stored in a computer readable storage medium, such as ROM/RAM (including various RAMs, such as DRAM, SRAM, DDR RAM, and so on), magnetic disc, optical disc, flash memory, and various non-volatile storage medium, and the like.

The embodiments as described above are just some preferred embodiments of the present invention, and are not used to limit the invention. Any modification, equivalent alternative or improvement that falls within the spirit and principle of the present invention should be embraced in the protection scope of the invention.

What is claimed is:

1. A batch selection method for multiple images, comprising:
detecting a slide touching event under an image editing mode;
acquiring a slide track of the slide touching event; and
setting unselected images within the image display area that the slide track passes through as a selected state, or setting selected images within the image display area that the slide track passes through as a unselected state.

2. The method as claimed in claim 1, wherein said setting the unselected images within the image display area that the slide track passes through as the selected state comprises:
when there exists at least one touch point of the slide track whose coordinate in the current interface is included in the image display area, setting the unselected images within the image display area as the selected state.

3. The method as claimed in claim 1, further comprising:
detecting a plurality of slide touching events under the image editing mode, and according to one detected slide touching event, acquiring a slide track of the slide touching event;
setting the unselected images within the image display area that the slide track passes through as the selected state, and continuing the detection of the next slide touching event, until another operation instruction is received.

4. The method as claimed in claim 1, wherein:
the image editing mode is one of predefined modes of performing operations on the images, the operations comprise selecting, deleting, uploading.

5. The method as claimed in claim 1, wherein:
the slide touching event comprises a slide-up touching event, a slide-down touching event, a slide-left touching event, a slide-right touching event, or an irregular slide touching event to any direction.

6. The method as claimed in claim 1, wherein:
the slide track acquired by every slide touching event is continuous under the image editing mode.

7. The method as claimed in claim 1, wherein:
the slide tracks between different slide touching events are uncontinuous.

8. A batch selection apparatus for multiple images, comprising:
a detection unit, configured to detect a slide touching event under an image editing mode;
a track acquisition unit, configured to acquire a slide track of the slide touching event; and
an image selection unit, configured to set unselected images within the image display area that the slide track passes through as a selected state, or set selected images within the image display area that the slide track passes through as a unselected state.

9. The apparatus as claimed in claim 8, wherein, the image selection unit is specifically configured to set, when there exists at least one touch point of the slide track whose coordinate in the current interface is included in the image display area, the unselected images within the image display area as the selected state, or the selected images within the image display area as the unselected state.

10. The apparatus as claimed in claim 8, wherein,
the detection unit is further configured to detect a plurality of slide touching events under the image editing mode;
the track acquisition unit is further configured to acquire a slide track of the slide touching event, according to one detected slide touching event; and
the image selection unit is further configured to set the unselected images within the image display area that the slide track passes through as the selected state, and continue the detection of the next slide touching event, until another operation instruction is received.

11. The apparatus as claimed in claim 8, wherein:
the image editing mode is one of predefined modes of performing operations on the images, the operations comprise selecting, deleting, uploading.

12. The apparatus as claimed in claim 8, wherein:
the slide touching event comprises a slide-up touching event, a slide-down touching event, a slide-left touching event, a slide-right touching event, or an irregular slide touching event to any direction.

13. The apparatus as claimed in claim 8, wherein:
the slide track acquired by every slide touching event is continuous under the image editing mode.

14. The apparatus as claimed in claim 8, wherein:
the slide tracks between different slide touching events are uncontinuous.

15. The apparatus as claimed in claim 8, wherein:
the apparatus runs one of the following mobile operating systems: Symbian OS, iOS, Blackberry, Windows Phone, Linux, Web OS, Android, Tizen.

16. The apparatus as claimed in claim 8, wherein:
the apparatus runs one of the following desktop operating systems: UNIX, OS X, Linux, Chromium OS, Windows.
